(19) United States
(12) Patent Application Publication
(10) Pub. No.: US 2024/0277059 A1
(43) Pub. Date: Aug. 22, 2024

(54) AEROSOL GENERATING DEVICE

(71) Applicant: Nicoventures Trading Limited, London (GB)

(72) Inventors: Dean COWAN, London (GB); Matthew HODGSON, London (GB); Jeremy CAMPBELL, London (GB)

(21) Appl. No.: 18/571,488

(22) PCT Filed: Jun. 17, 2022
(86) PCT No.: PCT/EP2022/066634

§ 371 Date: Dec. 18, 2023

(30) Foreign Application Priority Data
Jun. 18, 2021 (GB) 2108797.8

(51) Int. Cl. A24F 40/465; A24F 40/20; A24F 40/485

(52) U.S. Cl. CPC A24F 40/465; A24F 40/20; A24F 40/485

(57) ABSTRACT

An aerosol generating device (101) is described. The device (101) generates an aerosol from aerosol-generating material. The device (101) has a receptacle (212) defining a heating zone (215) in which at least a portion of an article (110) comprising aerosol-generating material is received. A heating element (220) protrudes into the heating zone (215). The heating element (220) comprises a peripheral surface (223). At least a portion of the peripheral surface (223) is tapered.

### RELATED APPLICATIONS

The present application is a National Phase Entry of PCT Application No. PCT/EP2022/066634 filed Jun. 17, 2022, which claims priority to GB Application No. 2108797.8 filed Jun. 18, 2021, each of which is hereby incorporated by reference in their entirety.

### TECHNICAL FIELD

The present invention relates to aerosol generating device for generating an aerosol from aerosol-generating material. The present invention also relates to an aerosol provision system comprising an aerosol generating device and an article comprising aerosol-generating material.

### BACKGROUND OF THE INVENTION

Smoking articles such as cigarettes, cigars and the like burn tobacco during use to create tobacco smoke. Attempts have been made to provide alternatives to these articles that burn tobacco by creating products that release compounds without burning. Examples of such products are heating devices which release compounds by heating, but not burning, the material. The material may be for example tobacco or other non-tobacco products, which may or may not contain nicotine.

### SUMMARY OF THE INVENTION

According to an aspect, there is provided an aerosol generating device for generating an aerosol from aerosol-generating material comprising: a receptacle defining a heating zone configured to receive at least a portion of an article comprising aerosol-generating material, a heating element protruding into the heating zone; wherein the heating element comprises a peripheral surface; and at least a portion of the peripheral surface is tapered.

The heating element may be configured to be heated to a temperature sufficient to generate aerosol from the aerosol generating material.

The heating element may be elongate and a substantive portion of the peripheral surface may be tapered in a longitudinal direction of the heating element.

At least one third of the heating element may comprise the tapered peripheral surface. At least half of the heating element may comprise the tapered peripheral surface.

At least 90 percent of the heating element may comprise the tapered peripheral surface.

The tapered peripheral surface may extend between opposing ends of the heating element. The heating element may be tapered along its length. The heating element may be tapered along its entire length. The heating element may comprise a frustum shape. The heating element may comprise a pyramidal shape, such as a conical shape.

The taper of the heating element may vary along its longitudinal length.

The heating element comprises a first portion and a second portion, wherein an angle of taper of the first portion may be greater than an angle of taper of the second portion.

The first portion may be a tapered portion and the second portion may be a non-tapered portion.

The device may comprise a base at a distal end of the receptacle from which the heating element protrudes into the heating zone, and a proximal end.

The second portion may be at the distal end.

The second portion may comprise a neck.

The first and second portions may be integrally formed. As used herein, the term ‘integrally formed’ is intended to mean that the features are not separable.

The first and second portions may be a one-piece component. As used herein, the term ‘one piece component’ is intended to mean that the features are formed together such that no joints are defined therebetween.

The device may comprise a base a base at a distal end of the receptacle from which the heating element protrudes into the heating zone, and a proximal end.

The heating element may comprise a third portion, and wherein the third portion is at the distal end.

The third portion may comprise a neck. The third portion may be free from heating material that is heatable by penetration with a varying magnetic field.

A dimension perpendicular to a longitudinal axis of the heating element of the first portion at the juncture of the first and second portion may be less than a dimension perpendicular to a longitudinal axis of the heating element of the first portion. A maximum diameter of the first portion may be less than a maximum diameter of the first portion.

The receptacle may comprise a base and the neck may define a recess at the base.

The device may comprise an air outlet in fluid communication with the heating zone to supply air to the heating zone. The air outlet may be in the recess.

The heating element may be truncated.

The heating element may comprise heating material that is heatable by penetration with a varying magnetic field.

The first portion may comprise heating material that is heatable by penetration with a varying magnetic field.

The second portion may comprise heating material that is heatable by penetration with a varying magnetic field.

The taper may extend at an angle of between 5 degrees and 30 degrees relative to a longitudinal axis of the heating element. The taper may extend at an angle of between 10 degrees and 15 degrees relative to a longitudinal axis of the heating element. The taper may extend at an angle of between 15 degrees and 20 degrees relative to a longitudinal axis of the heating element.

The taper may extend at an angle of at least 5 degrees relative to a longitudinal axis of the heating element. The taper may extend at an angle of at least 10 degrees relative to a longitudinal axis of the heating element. The taper may extend at an angle of at least 15 degrees relative to a longitudinal axis of the heating element.

The receptacle may be free from heating material that is heatable by penetration with a varying magnetic field.

The device may comprise a magnetic field generator including an inductor coil configured to generate a varying magnetic field.

The inductor coil may be a helical inductor coil.

The inductor coil may be a helical inductor coil. The inductor coil may be at least one of a planar coil and a spiral coil. The spiral coil may be a flat spiral coil.

The heating element may comprise part of a resistive heating arrangement.

The apparatus of this aspect can include one or more, or all, of the features described below, as appropriate.

According to an aspect, there is provided an aerosol generating device for generating an aerosol from aerosol-generating material comprising: a receptacle defining a heating zone configured to receive at least a portion of an article comprising aerosol-generating material, and a heating element protruding into the heating zone; wherein the heating element comprises a neck.

The heating element may comprise a first portion and a second portion, the second portion extending between the receptacle and the first portion; and wherein the second portion forms the neck.

The second portion may comprise a column.

The first portion may form a step at a juncture with the second portion.

A dimension of the first portion in a direction perpendicular to a longitudinal axis of the heating element may be greater that a dimension of the second portion in a direction perpendicular to a longitudinal axis of the heating element at the juncture of the first and second portions. A maximum diameter of the first portion may be less than a maximum diameter of the first portion.

The second portion may comprise a taper.

The receptacle may comprise a base and the neck may define a recess at the base.

The device may comprise an air outlet in fluid communication with the heating zone to supply air to the heating zone. The air outlet may be in the recess.

The air outlet may be in the base.

The air outlet may be in the neck.

The neck may be free from heating material that is heatable by penetration with a varying magnetic field.

The heating element may comprise a portion extending external from the receptacle. The heating element may comprise a first portion external to the heating zone and a second portion protruding in the heating zone. The portion extending external from the receptacle may be heated and be thermally conductively connected with the portion of the heating element in the heating zone. As used herein, the term ‘conductively connected between’ does not necessarily mean that two features are directly connected between, and such an arrangement may include one or further features therebetween.

According to an aspect, there is provided an aerosol provision system comprising the aerosol generating device as described by any of the above and an article comprising aerosol generating material.

According to an aspect, there is provided an aerosol-generating system comprising: an article comprising aerosol-generating material; an aerosol generating device for heating aerosol-generating material comprising a receptacle defining a heating zone configured to receive at least a portion of the article; and a heating element that protrudes into the heating zone; wherein the heating element comprises a peripheral surface; and at least a portion of the peripheral surface is tapered.

According to an aspect, there is provided an aerosol-generating system comprising: an article comprising aerosol-generating material; an aerosol generating device for heating aerosol-generating material comprising a receptacle defining a heating zone configured to receive at least a portion of the article; and a heating element that protrudes into the heating zone; wherein the heating element comprises a neck.

The article may comprise a pre-formed bore configured to receive the heating element.

The article may be a consumable.

The heating element may be configured to seal with a face of the bore.

The article may comprise an engaging feature configured to engage with the heating element.

The engaging feature may be at least one of a bore, a collar, a shoulder, a ridge, a protrusion, a recess, a lip, a chamfer, a region of increased thickness, a region of reduced thickness, a face and an edge.

The heating element may be removable from the heating zone. The heating element may be interchangeable.

The heating element may upstand from the base. The heating element may comprise a sharp edge or point at a free end. The heating element may be a pin or blade. The heating element may be configured to pierce the article received by the heating zone.

The heating element and receptacle may be co-axial.

The apparatus of this aspect can include one or more, or all, of the features described above, as appropriate.

The aerosol generating device may be a non-combustible aerosol generating device.

The device may be a tobacco heating device, also known as a heat-not-burn device.

The aerosol generating material may be non-liquid aerosol generating material.

The article may be dimensioned to be at least partially received within the heating zone.

According to an aspect, there is provided an aerosol generating device for generating an aerosol from aerosol-generating material comprising: a receptacle defining a heating zone configured to receive at least a portion of an article comprising aerosol-generating material, and a heating element arranged to heat the heating zone.

According to an aspect, there is provided an aerosol-generating system comprising an article comprising aerosol-generating material; an aerosol generating device for heating aerosol-generating material comprising a heating zone configured to receive at least a portion of the article; and a heating element.

According to an aspect, there is provided an aerosol generating device for generating an aerosol from aerosol-generating material comprising: a heating element configured to be received within at least a portion of an article comprising aerosol-generating material; a base from which the heating element protrudes; wherein the heating element comprises a peripheral surface; and at least a portion of the peripheral surface is tapered.

The device may comprise a heating zone around the heating element configured to at least partially receive the article comprising aerosol-generating material.

The device may comprise a housing, wherein the housing defines the base.

At least part of the heating element may be exposed.

The base may comprise an upstanding rim extending around and spaced from a base end of the heating element.

The heating element may be configured to be heated to a temperature sufficient to generate aerosol from the aerosol generating material.

The heating element may be elongate and a substantive portion of the peripheral surface may be tapered in a longitudinal direction of the heating element.

At least one third of the heating element may comprise the tapered peripheral surface.

At least half of the heating element may comprise the tapered peripheral surface. At least 90 percent of the heating element may comprise the tapered peripheral surface.

The tapered peripheral surface may extend between opposing ends of the heating element. The heating element may be tapered along its length. The heating element may be tapered along its entire length. The heating element may comprise a frustum shape. The heating element may comprise a pyramidal shape, such as a conical shape.

The taper of the heating element may vary along its longitudinal length.

The heating element comprises a first portion and a second portion, wherein an angle of taper of the first portion may be greater than an angle of taper of the second portion.

The first portion may be a tapered portion and the second portion may be a non-tapered portion.

The heating element may comprise a base end.

The second portion may be at a base end of the heating element.

The second portion may comprise a neck.

The first and second portions may be integrally formed. As used herein, the term ‘integrally formed’ is intended to mean that the features are not separable.

The first and second portions may be a one-piece component. As used herein, the term ‘one piece component’ is intended to mean that the features are formed together such that no joints are defined therebetween.

The heating element may comprise a base end.

The heating element may comprise a third portion, and wherein the third portion is at the base end.

The third portion may comprise a neck. The third portion may be free from heating material that is heatable by penetration with a varying magnetic field.

A dimension perpendicular to a longitudinal axis of the heating element of the first portion at the juncture of the first and second portion may be less than a dimension perpendicular to a longitudinal axis of the heating element of the first portion. A maximum diameter of the first portion may be less than a maximum diameter of the first portion.

The neck may define a recess at the base.

The device may comprise an air outlet in fluid communication with the heating zone to supply air to the heating zone. The air outlet may be in the recess.

The heating element may be truncated.

The heating element may comprise heating material that is heatable by penetration with a varying magnetic field.

The first portion may comprise heating material that is heatable by penetration with a varying magnetic field.

The second portion may comprise heating material that is heatable by penetration with a varying magnetic field.

The taper may extend at an angle of between 5 degrees and 30 degrees relative to a longitudinal axis of the heating element. The taper may extend at an angle of between 10 degrees and 15 degrees relative to a longitudinal axis of the heating element. The taper may extend at an angle of between 15 degrees and 20 degrees relative to a longitudinal axis of the heating element.

The taper may extend at an angle of at least 5 degrees relative to a longitudinal axis of the heating element. The taper may extend at an angle of at least 10 degrees relative to a longitudinal axis of the heating element. The taper may extend at an angle of at least 15 degrees relative to a longitudinal axis of the heating element.

The housing may be free from heating material that is heatable by penetration with a varying magnetic field.

The device may comprise a magnetic field generator including an inductor coil configured to generate a varying magnetic field.

The inductor coil may be a helical inductor coil.

The inductor coil may be a helical inductor coil. The inductor coil may be at least one of a planar coil and a spiral coil. The spiral coil may be a flat spiral coil.

The heating element may comprise part of a resistive heating arrangement.

According to an aspect, there is provided an aerosol generating device for generating an aerosol from aerosol-generating material comprising: a heating element configured to be received within at least a portion of an article comprising aerosol-generating material; a base from which the heating element protrudes; wherein the heating element comprises a neck.

The device may comprise a heating zone around the heating element configured to at least partially receive the article comprising aerosol-generating material.

The device may comprise a housing, wherein the housing defines the base.

At least part of the heating element may be exposed.

The base may comprise an upstanding rim extending around and spaced from a base end of the heating element.

The heating element may comprise a first portion and a second portion, the second portion extending between the base and the first portion; and wherein the second portion forms the neck.

The second portion may comprise a column.

The first portion may form a step at a juncture with the second portion.

A dimension of the first portion in a direction perpendicular to a longitudinal axis of the heating element may be greater that a dimension of the second portion in a direction perpendicular to a longitudinal axis of the heating element at the juncture of the first and second portions. A maximum diameter of the first portion may be less than a maximum diameter of the first portion.

The second portion may comprise a taper.

The neck may define a recess at the base.

The device may comprise an air outlet in fluid communication with the heating zone to supply air to the heating zone. The air outlet may be in the recess.

The air outlet may be in the base.

The air outlet may be in the neck.

The neck may be free from heating material that is heatable by penetration with a varying magnetic field.

According to an aspect, there is provided an aerosol-generating system comprising: an article comprising aerosol-generating material; an aerosol generating device for heating aerosol-generating material comprising a heating element configured to be received within at least a portion of an article comprising aerosol-generating material a base from which the heating element protrudes; wherein the heating element comprises a peripheral surface; and at least a portion of the peripheral surface is tapered.

According to an aspect, there is provided an aerosol-generating system comprising: an article comprising aerosol-generating material; an aerosol generating device for heating aerosol-generating material comprising a heating element configured to be received within at least a portion of an article comprising aerosol-generating material; a base from which the heating element protrudes; wherein the heating element comprises a neck.

The article may comprise a pre-formed bore configured to receive the heating element.

The article may be a consumable.

The heating element may be configured to seal with a face of the bore.

The article may comprise an engaging feature configured to engage with the heating element.

The engaging feature may be at least one of a bore, a collar, a shoulder, a ridge, a protrusion, a recess, a lip, a chamfer, a region of increased thickness, a region of reduced thickness, a face and an edge.

The heating element may be removable from device. The heating element may be interchangeable.

The heating element may upstand from the base. The heating element may comprise a sharp edge or point at a free end. The heating element may be a pin or blade. The heating element may be configured to pierce the article received by the heating zone.

The apparatus of this aspect can include one or more, or all, of the features described above, as appropriate.

The aerosol generating device may be a non-combustible aerosol generating device.

The device may be a tobacco heating device, also known as a heat-not-burn device.

The aerosol generating material may be non-liquid aerosol generating material.

According to an aspect, there is provided an aerosol generating device for generating an aerosol from aerosol-generating material, the device comprising:
a housing;
an exposed heating arrangement protruding from the housing configured to be received within an aerosol-generating article and heat the aerosol-generating article.

The heating arrangement may comprise a heating element protruding from the housing configured to be received within an aerosol-generating article.

The housing may comprise a base from which the heating element protrudes.

The heating arrangement may comprise a peripheral surface; and at least a portion of the peripheral surface may be tapered. The heating element may comprise a peripheral surface; and at least a portion of the peripheral surface may be tapered.

The heating arrangement may comprise a neck. The heating element may comprise a neck.

A heating zone may extend around the exposed heating arrangement and be configured to at least partially receive the article comprising aerosol-generating material.

According to an aspect, there is provided, an aerosol-generating system comprising: an article comprising aerosol-generating material; and an aerosol generating device for heating aerosol-generating material according to the above.

The apparatus of these aspects can include one or more, or all, of the features described above, as appropriate.

### BRIEF DESCRIPTION OF THE DRAWINGS

Embodiments will now be described, by way of example only, and with reference to the accompanying drawings in which:

FIG. 1 shows a front perspective view of an aerosol generating system with an aerosol generating device and an article inserted into the device;

FIG. 2 shows schematically the aerosol generating system of FIG. 1;

FIG. 2A shows schematically an aerosol generating system with an aerosol generating device and an article for use with the device;

FIG. 2B shows schematically part of an aerosol generating device;

FIG. 3 shows schematically part of the aerosol generating system of FIG. 1 with the article partially withdrawn from the device;

FIG. 4 shows schematically part of another arrangement of the aerosol generating system of FIG. 1 with the article partially withdrawn from the device;

FIG. 5 shows schematically part of another arrangement of the device of the aerosol generating system of FIG. 1;

FIG. 6 shows schematically part of another arrangement of the device of the aerosol generating system of FIG. 1;

FIG. 7 shows schematically part of another arrangement of the device of the aerosol generating system of FIG. 1; and

FIG. 8 shows schematically part of another arrangement of the device of the aerosol generating system of FIG. 1.

### DETAILED DESCRIPTION

As used herein, the term “aerosol-generating material” includes materials that provide volatilized components upon heating, typically in the form of an aerosol. Aerosol-generating material may include any plant based material, such as tobacco-containing material and may, for example, include one or more of tobacco, tobacco derivatives, expanded tobacco, reconstituted tobacco or tobacco substitutes. Aerosol-generating material also may include other, non-tobacco, products, which, depending on the product, may or may not contain nicotine. Aerosol generating material may for example be in the form of a solid, a liquid, a gel, a wax or the like. Aerosol-generating material may for example also be a combination or a blend of materials. Aerosol-generating material may also be known as “smokable material”.

The aerosol-generating material may comprise a binder and an aerosol former.

Optionally, an active and/or filler may also be present. Optionally, a solvent, such as water, is also present and one or more other components of the aerosol-generating material may or may not be soluble in the solvent. In some embodiments, the aerosol-generating material is substantially free from botanical material. In some embodiments, the aerosol-generating material is substantially tobacco free.

The aerosol-generating material may comprise or be an “amorphous solid”. The amorphous solid may be a “monolithic solid”. In some embodiments, the amorphous solid may be a dried gel. The amorphous solid is a solid material that may retain some fluid, such as liquid, within it. In some embodiments, the aerosol-generating material may, for example, comprise from about 50 wt %, 60 wt % or 70 wt % of amorphous solid, to about 90 wt %, 95 wt % or 100 wt % of amorphous solid.

The aerosol-generating material may comprise an aerosol-generating film. The aerosol-generating film may comprise or be a sheet, which may optionally be shredded to form a shredded sheet. The aerosol-generating sheet or shredded sheet may be substantially tobacco free.

Apparatus is known that heats aerosol generating material to volatilized at least one component of the aerosol generating material, typically to form an aerosol which can be inhaled, without burning or combusting the aerosol generating material. Such apparatus is sometimes described as an “aerosol generating device”, an “aerosol provision device”, a “heat-not-burn device”, a “tobacco heating product device” or a “tobacco heating device” or similar. Similarly, there are also so-called e-cigarette devices, which typically vaporize an aerosol generating material in the form of a liquid, which may or may not contain nicotine.

The aerosol generating material may be in the form of or be provided as part of a rod, cartridge or cassette or the like which can be inserted into the apparatus. A heater for heating and volatilising the aerosol generating material may be provided as a “permanent” part of the apparatus.

An aerosol generating device can receive an article comprising aerosol generating material for heating. An “article” in this context is a component that includes or contains in use the aerosol generating material, which is heated to volatilized the aerosol generating material, and optionally other components in use. A user may insert the article into the aerosol provision device before it is heated to produce an aerosol, which the user subsequently inhales. The article may be, for example, of a predetermined or specific size that is configured to be placed within a heating chamber of the device which is sized to receive the article.

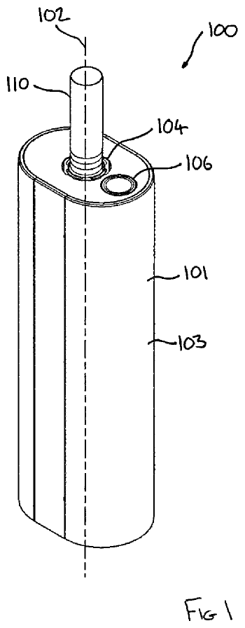

FIG. 1 shows an example of an aerosol generating system 100. The system 100 comprises an aerosol generating device 101 for generating aerosol from an aerosol generating medium/material, and a replaceable article 110 comprising the aerosol generating medium.

The device 101 can be used to heat the replaceable article 110 comprising the aerosol generating medium, to generate an aerosol or other inhalable medium which can be inhaled by a user of the device 101.

The device 101 comprises a housing 103 which surrounds and houses various components of the device 101. The housing 103 is elongate. The device 101 has an opening 104 in one end, through which the article 110 can be inserted for heating by the device 101. The article 110 may be fully or partially inserted into the device 101 for heating by the device 101.

In various embodiments, the device 101 is free from an opening. In such an arrangement, the device 101, or a component of, may be partially received within at least a portion of the article 110.

The device 101 may comprise a user-operable control element 106, such as a button or switch, which operates the device 101 when operated, e.g. pressed. For example, a user may activate the device 101 by pressing the switch 106.

The device 101 defines a longitudinal axis 102, along which an article 110 may extend when inserted into the device 101. The opening 104 is aligned on the longitudinal axis 102.

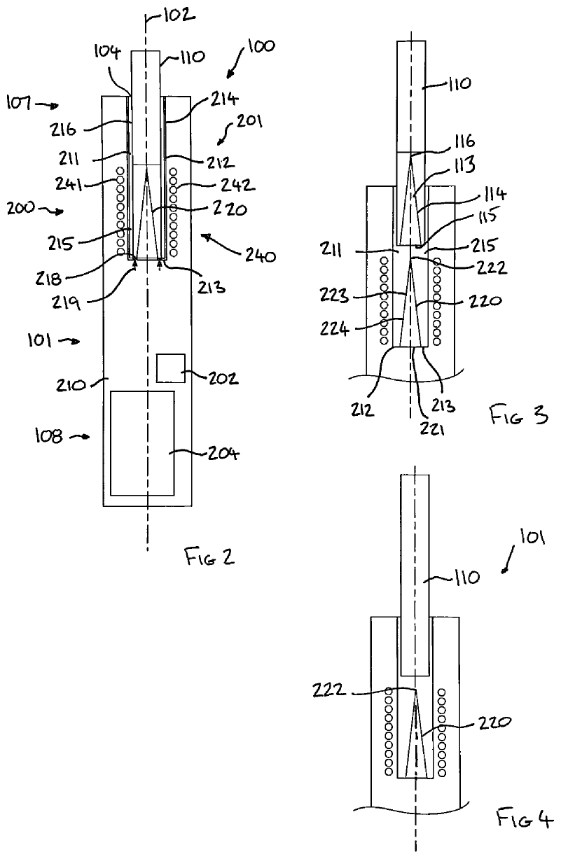

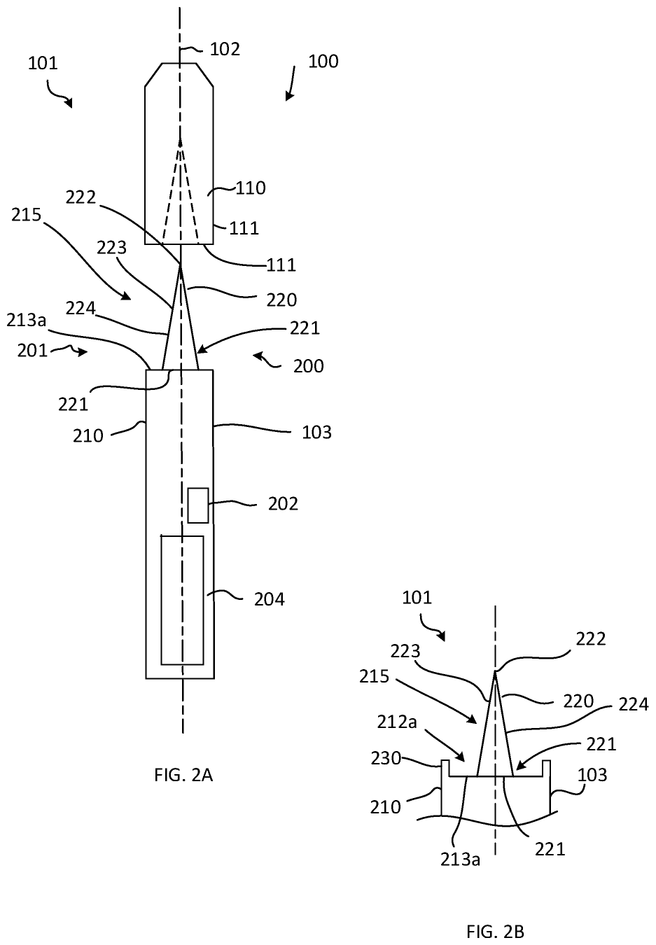

FIG. 2 is a schematic illustration of the aerosol generating system 100 of FIG. 1, showing various components of the device 101. It will be appreciated that the device 101 may include other components not shown in FIG. 2.

As shown in FIG. 2, the device 101 includes an apparatus for heating aerosol generating material 200. The apparatus 200 includes a heating assembly 201, a controller (control circuit) 202, and a power source 204. The apparatus 200 comprises a body assembly 210. The body assembly 210 may include a chassis and other components forming part of the device. The heating assembly 201 is configured to heat the aerosol-generating medium or material of an article 110 inserted into the device 101, such that an aerosol is generated from the aerosol generating medium. The power source 204 supplies electrical power to the heating assembly 201, and the heating assembly 201 converts the supplied electrical energy into heat energy for heating the aerosol-generating material.

The power source 204 may be, for example, a battery, such as a rechargeable battery or a non-rechargeable battery. Examples of suitable batteries include, for example, a lithium battery (such as a lithium-ion battery), a nickel battery (such as a nickel-cadmium battery), and an alkaline battery.

The power source 204 may be electrically coupled to the heating assembly 201 to supply electrical power when required and under control of the controller 202 to heat the aerosol generating material. The control circuit 202 may be configured to activate and deactivate the heating assembly 201 based on a user operating the control element 106. For example, the controller 202 may activate the heating assembly 201 in response to a user operating the switch 106.

The end of the device 101 closest to the opening 104 may be known as the proximal end (or mouth end) 107 of the device 101 because, in use, it is closest to the mouth of the user. In use, a user inserts an article 110 into the opening 104, operates the user control 106 to begin heating the aerosol generating material and draws on the aerosol generated in the device. This causes the aerosol to flow through the article 110 along a flow path towards the proximal end of the device 101.

The other end of the device furthest away from the opening 104 may be known as the distal end 108 of the device 101 because, in use, it is the end furthest away from the mouth of the user. As a user draws on the aerosol generated in the device, the aerosol flows in a direction towards the proximal end of the device 101. The terms proximal and distal as applied to features of the device 101 will be described by reference to the relative positioning of such features with respect to each other in a proximal-distal direction along the axis 102.

The heating assembly 201 may comprise various components to heat the aerosol generating material of the article 110 via an inductive heating process. Induction heating is a process of heating an electrically conducting heating element (such as a susceptor) by electromagnetic induction. An induction heating assembly may comprise an inductive element, for example, one or more inductor coils, and a device for passing a varying electric current, such as an alternating electric current, through the inductive element. The varying electric current in the inductive element produces a varying magnetic field. The varying magnetic field penetrates a susceptor (heating element) suitably positioned with respect to the inductive element, and generates eddy currents inside the susceptor. The susceptor has electrical resistance to the eddy currents, and hence the flow of the eddy currents against this resistance causes the susceptor to be heated by Joule heating. In cases where the susceptor comprises ferromagnetic material such as iron, nickel or cobalt, heat may also be generated by magnetic hysteresis losses in the susceptor, i.e. by the varying orientation of magnetic dipoles in the magnetic material as a result of their alignment with the varying magnetic field. In inductive heating, as compared to heating by conduction for example, heat is generated inside the susceptor, allowing for rapid heating. Further, there need not be any physical contact between the inductive element and the susceptor, allowing for enhanced freedom in construction and application.

The apparatus 200 includes a heating chamber 211 configured and dimensioned to receive the article 110 to be heated. The heating chamber 211 defines a heating zone 215. In the present example, the article 110 is generally cylindrical, and the heating chamber 211 is correspondingly generally cylindrical in shape. However, other shapes would be possible. The heating chamber 211 is formed by a receptacle 212. The receptacle 212 includes an end wall 213 and a peripheral wall 214. The end wall 213 acts as a base of the receptacle 212. The receptacle 212 in embodiments is a one-piece component. In other embodiments the receptacle comprises two or more components.

The heating chamber 211 is defined by the inner surfaces of the receptacle 212. The receptacle 212 acts as a support member. The receptacle 212 comprises a generally tubular member. The receptacle 212 extends along and around and substantially coaxial with the longitudinal axis 102 of the device 101. However, other shapes would be possible. The receptacle 212 (and so heating zone 215) is open at its proximal end such that an article 110 inserted into the opening 104 of the device 101 can be received by the heating chamber 211 therethrough. The receptacle 212 is closed at its distal end by the end wall 213. The receptacle 212 comprises an air conduit 218 that form part of an air path (indicated by arrows 219). The air conduit 218 extends through the base 213. In use, the distal end of the article 110 may be positioned in proximity or engagement with the end of the heating chamber 211. Air may pass through one or more conduits 218 forming part of the air path, into the heating chamber 211, and flow through the article 110 towards the proximal end of the device 101.

The receptacle 212 is formed free of material that is heatable by penetration with a varying magnetic field. The receptacle 212 may be formed from an insulating material. For example, the receptacle 212 may be formed from a plastic, such as polyether ether ketone (PEEK). Other suitable materials are possible. The receptacle 212 may be formed from such materials ensure that the assembly remains rigid/solid when the heating assembly 201 is operated. Using a non-metallic material for the receptacle 212 may assist with restricting heating of other components of the device 101. Use of a non-metallic material for the receptacle may assist with induction heating by minimising any interference with the magnetic field. The receptacle 212 may be formed from a rigid material to aid support of other components.

Other arrangements for the receptacle 212 would be possible. For example, in an embodiment the end wall 213 is defined by part of the heating assembly 201. In embodiments, the receptacle 212 comprises material that is heatable by penetration with a varying magnetic field.

As illustrated in FIG. 2, the heating assembly 201 comprises a heating element 220. The heating element 220 is configured to heat the heating zone 215. The heating zone 215 is defined in the heating chamber 211. In embodiments the heating chamber 211 defines a portion of the heating zone 215 or the extent of the heating zone 215.

The heating zone 215 is a zone or volume into which an article may be received for heating by the device 101. The heating zone 215 is defined therefore at least in part by the heating assembly 201. The heating zone 215 is a space adjacent to the heating element 220. In embodiments comprising the heating chamber 211, such as shown in FIG. 2, the heating chamber 211 delimits the heating zone 215. That is, the heating chamber defines the heating zone 215. In embodiments, the heating element 220 defines the heating zone.

As illustrated in FIG. 2A, in various embodiments the apparatus 200 is free from a heating chamber. The heating element protrudes from the housing 103. In such embodiments, the receptacle and heating chamber may be omitted, and the heating element may be surrounded by free space. The heating element, or at least part of the heating element, is free from being surrounded by a peripheral member, such as a peripheral wall of the device when the article is on the heating element. The term ‘heating zone’ will be understood to include a space surrounding the heating element. That is, the heating zone may not be defined or delimited by a component of the device 101.

In embodiments, the heating element forms part of a heating arrangement. The heating arrangement comprises the heating element protruding from the base. In other embodiments, the heating element is in the article, and the heating arrangement comprises a protruding member protruding from the base. The heating element or protruding member in embodiments comprises the magnetic field generator configured to generate a varying magnetic field including an inductor coil. The heating arrangement in embodiments is an inductive heating arrangement. The heating arrangement in embodiments is a resistive heating arrangement.

The heating element 220 is heatable to heat the heating zone 215. The heating element 220 is an induction heating element. That is, the heating element 220 comprises a susceptor that is heatable by penetration with a varying magnetic field. The susceptor comprises electrically conducting material suitable for heating by electromagnetic induction. For example, the susceptor may be formed from a carbon steel. It will be understood that other suitable materials may be used, for example a ferromagnetic material such as iron, nickel or cobalt.

The heating assembly 201 comprises a magnetic field generator 240. The magnetic field generator 240 is configured to generate one or more varying magnetic fields that penetrate the susceptor so as to cause heating in the susceptor. The magnetic field generator 240 includes an inductor coil arrangement 241. The inductor coil arrangement 241 comprises an inductor coil 242, acting as an inductor element. The inductor coil 242 is a helical coil, however other arrangements are envisaged. In embodiments, the inductor coil arrangement 241 comprises two or more inductor coils 242. The two or more inductor coils in embodiments are disposed adjacent to each other and may be aligned co-axially along the axis.

In some examples, in use, the inductor coil 242 is configured to heat the susceptor to a temperature of between about 200° C. and about 350° C., such as between about 240° C. and about 300° C., or between about 250° C. and about 280° C.

The heating element 220 extends in the heating zone 215. The heating element 220, acting as a protruding element, protrudes in the heating zone 215. The heating element 220 upstands from the base 213.

In embodiments, the base is formed by a feature other than the end wall 213 of the receptacle.

The heating element 220 is spaced from the peripheral wall 214. The heating assembly 201 is configured such that when an article 110 is received by the heating chamber 211, the heating portion 221 of the heating element 220 extends into a distal end of the article 110. The heating element 220 is positioned, in use, within the article 110. The heating element 220 is configured to heat aerosol generating material of an article 110 from within, and for this reason is referred to as an inner heating element.

The heating element 220 extends into the heating chamber 211 from the distal end of the heating chamber 211 along the longitudinal axis 102 of the device (in the axial direction). In embodiments the heating element 220 extends into the heating chamber 211 spaced from the axis 102. The heating element 220 may be off-axis or non-parallel to the axis 102. Although one heating element 220 is shown, it will be understood that in embodiments, the heating assembly 201 comprises a plurality of heating elements 220. Such heating elements in embodiments are spaced from but parallel to each other.

The inductor coil 241 is disposed external to the receptacle 212. The inductor coil 241 encircles the heating zone 215. The helical inductor coil 241 extends around at least a portion of the heating element 220, acting as a susceptor. The helical inductor coil 241 is configured to generate a varying magnetic field that penetrates the heating element 220. The helical inductor coil 241 is arranged coaxially with the heating chamber 211 and longitudinal axis 101.

The inductor coil 241 is a helical coil comprising electrically-conductive material, such as copper. The coil is formed from wire, such as Litz wire, which is wound helically around a support member. The support member is formed by the receptacle 212 or by another component. In embodiments, the support member is omitted. The support member is tubular. The coil 241 defines a generally tubular shape. The inductor coil 241 has a generally circular profile. In other embodiments, the inductor coil 241 may have a different shape, such as generally square, rectangular or elliptical. The coil width may increase or decrease along its length.

Other types of inductor coil may be used, for example a flat spiral coil. With a helical coil it is possible to define an elongate inductor zone in which to receive a susceptor, which provides an elongate length of susceptor to be received in the elongate inductor zone. The length of susceptor subjected to varying magnetic field may be maximized. By providing an enclosed inductor zone with a helical coil arrangement it is possible to aid the flux concentration of the magnetic field.

Litz wire comprises a plurality of individual wires which are individually insulated and are twisted together to form a single wire. Litz wires are designed to reduce the skin effect losses in a conductor. Other wire types could be used, such as solid. The configuration of the helical inductor coil may vary along its axial length. For example, the inductor coil, or each inductor coil, may have substantially the same or different values of inductance, axial lengths, radii, pitches, numbers of turns, etc.

The heating element 220 protrudes in the heating zone 215 and is received by the article 110. FIG. 2 shows the article 110 received in the device 101. The article 110 is sized to be received by the receptacle 212. The outer dimensions of the article 110 perpendicular to the longitudinal axis of the article 110 substantially correspond with the inner dimensions of the chamber 211 perpendicular to the longitudinal axis 102 of the device 101 to allow insertion of the article 110 into the receptacle 212. In embodiments, a gap 216 is defined between an outer side 111 of the article 110 and an inner side 217 of the receptacle 212. The gap 216 may act as an air passage along at least part of the axial length of the chamber 211. An insertion end 112 of the article 110 is arranged to lie adjacent to the base of the receptacle 212.

FIG. 3 shows the article 110 partially inserted into the device 101. As shown, the article 110 is spaced from the heating element 220 in the heating zone 215.

The heating element 220 extends in the heating zone 215 from the distal end of the receptacle 212. The heating element 220 upstands from the end wall 213. The heating element 220 comprises a heating member 224. The heating member 224 is elongate. The heating element 220 comprises a base end 221 and an opposing free end 222. The heating portion 221 is a pin. Other shapes are envisaged, for example the heating portion 221 in embodiments is a blade.

The heating element 220 comprises a peripheral surface 223. The peripheral surface 223 extends around the heating element 220. The peripheral surface 223 extends between the base end 221 and the free end 222. The peripheral surface 223 forms an outer surface of the heating element.

The heating member 224 is a tapered member. The peripheral surface 223 is tapered. The heating member 224 converges in a direction from the base end 221 to the free end 222. The heating element 220 is conical although other shapes are envisaged. As shown in FIG. 3, the heating peripheral surface 223 is tapered along its entire length. In embodiments, for example as described below, a portion of the peripheral surface 223 is free from taper.

The peripheral surface 223 defines a longitudinal side of the heating member 224. The peripheral surface 223 forms the side wall or face of the heating element 220. The peripheral surface 223 is elongate and a substantive portion of the peripheral surface 223 is tapered in a longitudinal direction of the heating element 220. The peripheral surface 223 has a length in the longitudinal axis of between 10 mm and 30 mm. Optionally, the length of the peripheral surface 223 is between 15 mm and 25 mm.

By providing a tapered member it is possible to aid with providing progressive heating of the heating zone. It will be understood that the rate of heating of the susceptor and the area of susceptor material exposed to the aerosol-generating material will taper in the longitudinal direction and so may help progressive generation of vapor. Heat transfer across the aerosol-generating material of the article 110 may be relatively faster at the distal end and relatively slower towards the proximal end.

The peripheral surface 223 extends at an angle of up to 30 degrees relative to a longitudinal axis of the heating element. Optionally, the peripheral surface 223 extends at an angle of up to 15 degrees relative to a longitudinal axis of the heating element. Optionally, the peripheral surface 223 extends at an angle of up to 15 degrees relative to a longitudinal axis of the heating element. Optionally, the peripheral surface 223 extends at an angle of up to 5 degrees relative to a longitudinal axis of the heating element. In embodiments, the peripheral surface 223 extends at an angle of greater than 5 degrees relative to a longitudinal axis of the heating element to form the taper. Optionally, the peripheral surface 223 extends at an angle of greater than 10 degrees relative to a longitudinal axis of the heating element to form the taper.

The article 110 comprises a bore 113. The bore 113 is pre-formed in the article 110. The bore 113 is formed in embodiments by a tapered internal surface 114. The bore 113 in embodiments extends partially along the longitudinal axis of the article 110. The bore 113 comprises an inner surface 114. The bore 113 is open at an insertion end 115. The bore 113 has a closed end 115. The bore 113 tapers from the open end to the closed end 115. The heating element 220 is sized to be received in the bore 113. The heating element 220 and bore 113 are complimentary sized to form a contact fit. The inner surface 114 of the bore is configured to form a close contact with the heating member 224 to maximize heat transfer between the heating element 220 and the article 110. In embodiments where the configuration of the heating element 220 varies, the bore 113 is provided as a complimentary cavity. The bore 113 is tapered.

By providing a tapered arrangement, it is possible to aid location of the article 110 with the heating element 220. In a co-axial arrangement with corresponding article bore 113 the arrangement is able to self-centre and so aids alignment on insertion. Accordingly, the contact between heating element 220 and article 110 may be improved and so consistency of heating along the length of the heating element may be maximized. By providing a tapered profile, the robustness of the heating element 220 may be aided.

The free end 222 of the heating element 220 in the present embodiment extends to a tip. The tip is formed by the peripheral surface. In embodiments the free end 222 is blunt. The heating element 220 is conical. The shape of the heating element 220 may differ. The heating element 220, or at least the portion of the heating element formed by the peripheral wall 223, in embodiments has another pyramidal shape. The heating element 220 in embodiments is a frustum shape. FIG. 5 shows one example of the device 101 with a frustum shape heating element 230. The arrangement of the device 101 is generally the same as described above and so a detailed description will be omitted, and features of the device described above may be applied to the arrangement described below. As shown in FIG. 5 the heating element 230 is a truncated cone 231. A peripheral wall 232 is tapered. An end surface 233 is provided at the free end of the heating element 230. The end surface 233 extends transverse to the longitudinal axis of the heating element 230. In such an embodiment, the bore (not shown in FIG. 5) of the article 110 comprises a complimentary shape.

Referring to FIG. 4, in embodiments, the bore in the article 110 is omitted. The arrangement of the device 101 is generally the same as described above and so a detailed description will be omitted, and features of the device described above may be applied to the arrangement described below. In embodiments the outer dimensions of the heating element 220 are greater than those of the bore. In such arrangements, the heating element is configured to deform and/or distend the article 110 to be inserted into the article 110. To facilitate this, the inner heating element 220 is configured to pierce an article 110 that is inserted into the device 101. In such an embodiment, the free end 222 of the heating element 220 comprises a sharp edge or point. The free end 222 of the heating element 220 in embodiments comprises a sharp edge, point or other guide feature to aid location of the heating element 220 in the article 110. In embodiments in which the peripheral surface does not form a point, for example whereas a truncated shape, the heating element 220 may comprise a tip feature.

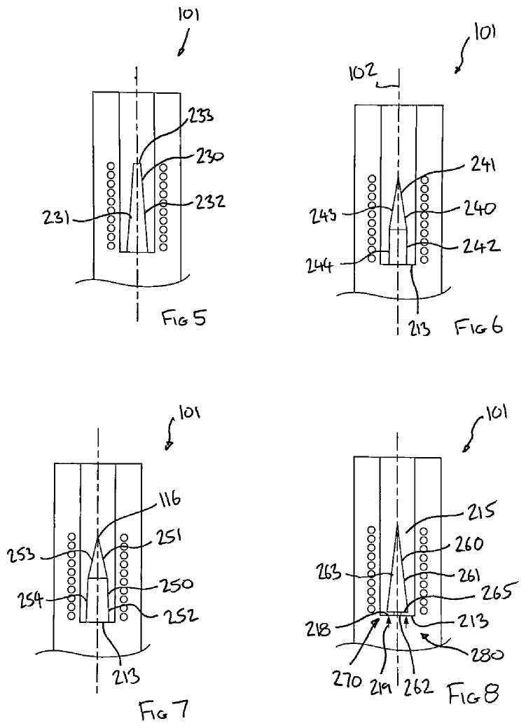

As shown in FIG. 3, the tapered peripheral surface extends between opposing ends of the heating element 220. In embodiments, at least 90 percent of the heating element comprises the tapered peripheral surface. As shown in FIG. 6, in some embodiments part of a heating element 240 is free of a taper. The arrangement of the device 101 is generally the same as described above and so a detailed description will be omitted, and features of the device described above may be applied to the arrangement described below. In embodiments, at least one third of the heating element comprises the tapered peripheral surface and, optionally, at least half of the heating element comprises the tapered peripheral surface.

The heating element 240 comprises a first portion 241 and a second portion 242. The first portion 241 is towards the proximal end and the second portion 242 is towards the distal end. The second portion 242 is between the base 213 and the first portion 241. The first portion 241 comprises a tapered peripheral surface 243. The second portion 242 is linear. A peripheral surface 244 of the second portion is free from taper. The second portion is cylindrical. The shape of the second portion 242 is complimentary with the profile shape of the first portion 241. As shown above the first portion 241 forms a major part of the heating element 240.

As shown in FIG. 7, in some embodiments a tapered heating element 250 has a varying taper only its length. The arrangement of the device 101 is generally the same as described above and so a detailed description will be omitted, and features of the device described above may be applied to the arrangement described below.

The heating element 250 comprises a first tapered portion 251 and a second tapered portion 252. The first tapered portion 251 is towards the proximal end and the second tapered portion 252 is towards the distal end. The second tapered portion 252 is between the base 213 and the first tapered portion 241. The first tapered portion 251 comprises a first tapered peripheral surface 253. The second tapered portion 252 comprises a tapered peripheral surface 254. The shape of the second tapered portion 252 is complimentary with the profile shape of the first tapered portion 251. As shown above the first tapered portion 251 forms a major part of the heating element 250.

The angle of taper of the first tapered portion 251 is greater than the angle of taper of the second tapered portion 252. The second tapered peripheral surface 254 converges in a direction from the base 213 to the first tapered portion 251. The first tapered peripheral surface 253 converges in a direction from the second tapered peripheral surface 254 to the free end 116. The second tapered peripheral surface 254 extends from the first tapered peripheral surface 253.

In some embodiments, a heating element 260 comprises a neck. One such embodiment is shown in FIG. 8. The arrangement of the device 101 is generally the same as described above and so a detailed description will be omitted, and features of the device described above may be applied to the arrangement described below.

The heating element 260 comprises a first portion 261 and a second portion 262. The first portion 261 is towards the proximal end and the second portion 262 is towards the distal end. The second portion 262 is between the base 213 and the first portion 261. The first portion 261 comprises a tapered peripheral surface 263.

The first portion 261 has a shape corresponding to the heating element shown in FIGS. 2 to 4. It will be understood that the shape of the first portion 261 may vary. In embodiments, the shape of the first portion 261 may have any of the shapes described above, for example with reference to FIGS. 5 to 7. Although in the above-described arrangements the heating element 260 comprises a tapered portion, it will be understood that in other embodiments a heating element comprising a neck does not include a tapered portion. For example, the first portion 262 in embodiments is cylindrical.

The second portion 262 forms a neck 270. The first portion 261 acts as the heating member. The neck 270 is inset from the first portion 261. In embodiments, the neck 270 has a maximum dimension in a direction perpendicular to a longitudinal axis of the heating element 260 less than a maximum dimension of the first portion 261 in a direction perpendicular to a longitudinal axis of the heating element 270. The neck 270 has a diameter less than the diameter of the first portion 261. The neck 270 extends to a juncture with the first portion 261. Although described herein as a second portion it will be understood that the neck 270 may be a third portion with the heating element comprising first and second portions.

The neck 270 defines a step at the juncture with the first portion 261. The neck 270 has a small axial extent. In embodiments, the neck 270 has a height of less than 2 mm and, optionally, less than 1 mm.

The neck 270 upstands from the base 213. As described herein, the neck 270 is part of the heating element 260. The neck 260 comprises heating material that is heatable by penetration with a varying magnetic field. In such an embodiment the neck 270 may be integrally formed and/or form a one piece component with the first portion 261. In another embodiment, the neck 270 is free from heating material that is heatable by penetration with a varying magnetic field. In such an embodiment, the neck 270 may be integrally formed and/or form a one piece component with the receptacle 212.

The neck 270 defines a recess 271 at the base 213. The recess 271 is defined between the base 213 and a lower end 265 of the first portion 261. The recess 271 extends circumferentially.

An air flow arrangement 280 is provided. The air flow arrangement 280 forms part of an air path through the heating zone 215. The air flow arrangement 280 comprises one or more of the air conduits forming part of the air path along which air may pass into the heating chamber 211. The air flows through the article in the heating chamber 211 towards the proximal end of the device 101. The air flow arrangement 280 comprises the air conduit 218 in the base 213. The air flows through the base 213 as indicated by arrows 219. The air conduit 218 communicates external to the receptacle 212 with the heating chamber 211. An air outlet is formed in the base 213. The air outlet is exposed to the recess 271. The air outlet comprises an array of apertures. The configuration and arrangement of the air flow arrangement 280, for example the array of aperture, may differ in embodiments. The array of apertures in embodiments is one or more apertures.

In the present embodiment the air outlet of the air conduit 218 is in the base 213. In embodiments, the air outlet of the air conduit 218 is in the neck 270. By providing an air outlet to fluidly communicate with the heating zone 215 in the recess 271, the first portion 261 acts as a barrier to help ensure that the air outlet is kept clear. Accordingly, it is possible to help provide an improved air flow path through the heating zone 215, for example by providing a diverging air flow volume.

FIG. 2A shows another embodiment. The embodiment of FIG. 2A corresponds generally to that of FIG. 2, except that the heating element 220 protrudes from the housing 103. In such an embodiment, the device is free from a receptacle. That is, the heating zone 215 is free from being surrounded or delimited by any other component.

The housing 103 defines the base 213a from which the heating element 220 protrudes. The heating element 220 upstands from the base 213a. The heating element 220 is configured to receive at least a portion of the article 110. The heating element 220 is exposed. The term ‘exposed’ will be understood to mean that a portion of a feature is not surrounded by another feature such that the feature extends beyond an external extent. The heating element 220 is not received in a heating chamber. With the device of FIG. 2A, the heating element extends beyond an external extent of the housing of the device. In the embodiment of FIG. 2A, the entire heating element 220 protruding from the base is free from being surrounded. In embodiments, a substantial portion of the heating element 220 exposed. In such an embodiment, a minor portion of the heating element extends within the external extent of the housing of the device. Optionally, at least 80% of the heating element 220 is exposed, optionally 60%, and optionally 50%.

The heating arrangement in embodiments is an inductive heating arrangement. The inductive coil may extend in the heating element 220. The heating arrangement in embodiments is a resistive heating arrangement.

FIG. 2A also shows an article 110 for use with any of the embodiments described herein. The article 110 of FIG. 2A is generally the same as the article 110 of FIG. 2. The article 110 of FIG. 2A may be used with the aerosol generating device 101 of FIG. 2A. The article 110 comprises the bore 113. The bore 113 may be omitted.

In embodiments, and as shown in FIG. 2B, the heating element 220 is exposed, with a portion of the heating element encircled by an upstanding rim 230 upstanding on the base 213a. The heating element 220 partially protrudes from the housing 103. That is, a portion of the heating element 220 protrudes from the housing 103 and a portion of the heating element 220 is surrounded by other components of the device. For example, the housing 103 may comprise an upstanding rim 230 extending around and spaced from the heating element 220. The upstanding rim 230 may extend around and be spaced from a base end 221 of the heating element 220. The upstanding rim 230 extends from the base 213a. The upstanding rim 230 extends circumferentially. The upstanding rim 230 may comprise a peripheral portion. The upstanding rim 230 of the base 213a forms a base recess 212a. The base recess 212a houses the base end 221 of the heating element 220. The base recess 212a may be configured to receive an end of the article 110. A major portion of the heating element 220 is free from being surrounded or delimited by any other component. The heating zone 215 is free from being surrounded or delimited by any other component.

FIGS. 2A and 2B show the heating element 220. The heating element 220 is generally the same as the heating element of FIG. 2. The heating element 220 comprises a heating member 224. The heating element 220 comprises a peripheral surface 223. The peripheral surface 223 extends around the heating element 220. The peripheral surface 223 extends between the base end 221 and the free end 222. The peripheral surface 223 forms an outer surface of the heating element 220. The heating member 224 is a tapered member. The peripheral surface 223 is tapered. The heating member 224 converges in a direction from the base end 221 to the free end 222. The heating element 220 is conical although other shapes are envisaged. As shown, the heating peripheral surface 223 is tapered along its entire length.

It will be understood that the exposed heating arrangement described above with reference to FIGS. 2A and 2B in embodiments is provided in combination with any other embodiment described above. For example, in embodiments, an exposed heating arrangement comprises a neck, such as described above with reference to FIG. 8. The arrangement of the device 101 is generally the same as described above and so a detailed description will be omitted. In the above-described arrangements, the heating element is formed from a material that is heatable by penetration with a varying magnetic field. In embodiments the heating element is solid. In other embodiments the heating element is hollow. In embodiments the heating element is a least partly hollow. In embodiments one or more portions of the heating element are hollow. In an embodiment, the heating element comprises a support and a heating member. The heating member is on the support. The heating member may be a layer, such as a coating, on the support. In an embodiment the heating member and/or support, if present, define a cavity.

In the above-described embodiments, the heating arrangement is an inductive heating arrangement. In embodiments, other types of heating arrangement are used, such as resistive heating. The configuration of the device is generally as described above and so a detailed description will be omitted. In such arrangements the heating assembly 201 comprises a resistive heating generator including components to heat the heating element via a resistive heating process. In this case, an electrical current is directly applied to a resistive heating component, and the resulting flow of current in the heating component causes the heating component to be heated by Joule heating. The resistive heating component comprises resistive material configured to generate heat when a suitable electrical current passes through it, and the heating assembly comprises electrical contacts for supplying electrical current to the resistive material.

In embodiments, the heating element forms the resistive heating component itself. In embodiments the resistive heating component transfers heat to the heating element, for example by conduction.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. An aerosol generating device for generating an aerosol from aerosol-generating material comprising:
a receptacle defining a heating zone configured to receive at least a portion of an article comprising aerosol-generating material; and
a heating element protruding into the heating zone;
wherein the heating element comprises a neck.

19. The device of claim 18, wherein the heating element comprises a first portion and a second portion, the second portion extending between the receptacle and the first portion; and wherein the second portion forms the neck.

20. The device of claim 18, wherein the first portion forms a step at a juncture with the second portion.

21. The device of claim 18, wherein the first portion comprises a taper.

22. The device of claim 18, wherein the receptacle comprises a base and the neck defines a recess at the base.

23. The device of claim 22, comprising an air outlet in fluid communication with the heating zone to supply air to the heating zone, wherein the air outlet is in the recess.

24. The device of claim 23, wherein the air outlet is in the base.

25. The device of claim 18, wherein the neck is free from heating material that is heatable by penetration with a varying magnetic field.

26. An aerosol provision system comprising the aerosol generating device of claim 1, and an article comprising aerosol generating material.

27. (canceled)

28. An aerosol-generating system comprising:
an article comprising aerosol-generating material; and
the aerosol generating device of claim 18.

29. The aerosol provision system of claim 28, wherein the article comprises a pre-formed bore configured to receive the heating element.

30. The aerosol provision system of claim 28, wherein the article is a consumable.

31. (canceled)

32. An aerosol generating device for generating an aerosol from aerosol-generating material comprising:
a heating element configured to be received within at least a portion of an article comprising aerosol-generating material;
a base from which the heating element protrudes;
wherein the heating element comprises a neck.

33. The device of claim 32, comprising a heating zone around the heating element configured to at least partially receive the article comprising aerosol-generating material.

34. The device of claim 32, comprising a housing, wherein the housing defines the base.

35. The device of claim 32, wherein at least part of the heating element is exposed.

36. The device of claim 32, wherein the base comprises an upstanding rim extending around and spaced from a base end of the heating element.

37. An aerosol generating device for generating an aerosol from aerosol-generating material comprising:
a receptacle defining a heating zone configured to receive at least a portion of an article comprising aerosol-generating material,
a heating element protruding into the heating zone;
wherein the heating element comprises a peripheral surface; and
at least a portion of the peripheral surface is tapered.

38. An aerosol-generating system comprising:
an article comprising aerosol-generating material; and
the aerosol generating device of claim 37.
